(19) United States
(12) Patent Application Publication
(10) Pub. No.: US 2024/0191382 A1
(43) Pub. Date: Jun. 13, 2024

(54) METHOD FOR PREPARING RARE EARTH ALLOYS

(71) Applicant: CENTRAL SOUTH UNIVERSITY, Changsha (CN)

(72) Inventors: Zhongwei ZHAO, Changsha (CN); Yuntao LEI, Changsha (CN); Fenglong SUN, Changsha (CN)

(73) Assignee: CENTRAL SOUTH UNIVERSITY, Changsha (CN)

(21) Appl. No.: 18/287,659

(22) PCT Filed: Apr. 25, 2022
(86) PCT No.: PCT/CN2022/088934

§ 371 Date: Oct. 20, 2023

(30) Foreign Application Priority Data
May 8, 2021 (CN) 202110499893.9

(51) Int. Cl. C25C 3/36; B01D 3/10; C22C 1/00; C22C 28/00; C25C 7/02

(52) U.S. Cl. CPC C25C 3/36; B01D 3/10; C22C 1/00; C22C 28/00; C25C 7/025

(57) ABSTRACT

A method for preparing rare earth alloys by molten salt electrolysis using rare earth oxides as the raw material is provided, where the electrolytic cell used is divided into the anode chamber and the cathode chamber containing melts such as anolyte, catholyte and liquid alloy. The method has the advantages of continuous production, high operability, low requirements on raw material purity and high quality of rare earth alloy products.

### CROSS REFERENCE TO THE RELATED APPLICATIONS

This application is the national phase entry of International Application No. PCT/CN2022/088934, filed on Apr. 25, 2022, which is based upon and claims priority to Chinese Patent Application No. 202110499893.9, filed on May 8, 2021, the entire contents of which are incorporated herein by reference.

### TECHNICAL FIELD

The present invention relates to the field of rare earth metallurgy, in particular to a method for preparing rare earth alloys by molten salt electrolysis.

### BACKGROUND

As a kind of key strategic rare metals, rare earth (RE) is widely used in the fields of national defense military, aerospace, electronic information, intelligent equipment, etc., and is known as “a modern industrial vitamin”. China is a country with the largest reserves of rare earth resources and the largest production of rare earth ores in the world. It has a complete rare earth industry chain covering mining and beneficiation in the upstream, leaching and separation and production of oxides and rare earth metals in the midstream, and development and application of rare earth materials in the downstream. At present, China's rare earth mineral leaching and extraction separation technology has reached the world's leading level, but there is still a huge space for development in high-performance rare earth alloy structural/functional materials and high-purity rare earth target material.

### SUMMARY

### Technical Problem

Rare earth alloys have distinctive properties. In terms of structural materials, adding rare earth elements to magnesium and aluminum to form rare earth light alloys can improve their processing properties, mechanical properties, heat and corrosion resistance. In terms of functional materials, Nd—Fe—B and Sm—Co rare earth alloys are important permanent magnetic materials, lanthanum-nickel alloys can be used as hydrogen storage materials in hydrogen fuel cells and nickel-hydrogen batteries, and terbium-iron alloys can be used in giant magnetostrictive materials.

Rare earth alloys (including rare earth intermediate alloy or master alloy) can be prepared by melt compounding, metallothermic reduction and molten salt electrolysis. Preparation of rare earth alloys by molten salt electrolysis has the advantages of continuous production, low cost, uniform composition and easiness in control. At present, most of the electrolytic cells used are vertical arrangement of cylindrical parallel or cluster electrodes. The rare earth metal or alloy products, rare earth oxide (REO) raw materials, graphite anode and fluoride molten salt are all in the same container. The products are easily contaminated by impurities such as C and O, and Fe, Si, Al and other rare earth impurities brought by the raw materials easily enter the products, thereby resulting in the decline of purity and quality of rare earth metals and alloys. In view of the fact that currently used electrolytic cells and electrolytic methods do not have the function of impurity removal and purification, in order to prepare high-purity rare earth metals and alloys, both the absolute purity and the relative purity of REO in the rare earth oxide raw materials have higher requirements (usually>99.90%), which undoubtedly increases the production cost of electrolytic process and the separation and purification pressure of upstream processes.

The present invention has been proposed in view of the above problems.

### Solution for the Problem

### Technical Solution

In order to solve the problems of the prior art, the present invention provides a method for preparing rare earth alloys by molten salt electrolysis using rare earth oxide as the raw material, which has advantages of low raw material requirements, high product quality and continuous production.

In order to achieve the above objective, the technical solution of the present invention is as follows:
the present invention relates to a method for preparing rare earth alloys, which is implemented using an electrolytic cell divided into the anode chamber and the cathode chamber, where the anolyte and the anode are provided in the anode chamber, catholyte and cathode are provided in the cathode chamber, liquid alloy is also contained at the bottom of the electrolytic cell, and the anolyte and the catholyte are not in contact with each other but are connected via the liquid alloy; the liquid alloy is used to construct electrochemical reaction interfaces with the anolyte and catholyte for rare earth metal atoms and earth metal ions, and served as the transfer medium of rare earth metal atoms;
the cathode is a solid consumable cathode or a liquid cathode; and
the electrolytic cell is powered on to operate, the rare earth oxide raw material is added to the anode chamber, and liquid rare earth alloy product is obtained in the cathode chamber.

The overall process can be summarized as: molten salt electrolysis reactions are performed at a certain temperature, the rare earth oxide raw material is added into the anode chamber, oxidation reaction occurs on the surface of the anode, and rare earth ions (in a dissolved state or/and an undissolved state) in the anode chamber are reduced to rare earth metal atoms at the interface between liquid alloy and anolyte and enter the liquid alloy; and in the cathode chamber, rare earth metal atoms in the liquid alloy are oxidized to rare earth ions at the interface between liquid alloy and catholyte and enter the catholyte, the rare earth ions in the catholyte are reduced to rare earth metal atoms at the cathode, and the rare earth metal atoms enter the liquid cathode to form the rare earth alloy product, or undergo alloying reaction with the solid consumable cathode to produce the rare earth alloy product.

An electrolysis temperature is generally selected to be 800-1100° C., depending on the melting points of the anolyte, catholyte and liquid alloy (so that all three are in liquid state), and also to meet the operating requirements of the solid consumable cathode or the liquid cathode.

In the rare earth oxide raw material, the content of total rare earth oxide is ≥ 90 wt %, and single rare earth oxide accounts for 90 wt % or above of the total rare earth oxide, where the single rare earth oxide is one of lanthanum oxide, cerium oxide, praseodymium oxide, neodymium oxide, samarium oxide, europium oxide, gadolinium oxide, terbium oxide, dysprosium oxide, holmium oxide, erbium oxide, thulium oxide, ytterbium oxide, lutetium oxide, yttrium oxide and scandium oxide.

The rare earth oxide raw material may come from a common rare earth oxide which meets or does not meet a national standard produced by metallurgical plants, and may also be mixed with some secondary resources containing rare earth elements, such as waste fluorescent powder and molten salt electrolytic slag.

The relative purity of the single rare earth metal in the rare earth alloy product is ≥ 99.0 wt %. Here, relative purity refers to the mass percentage of the single rare earth metal to the total rare earth metals in the rare earth alloy product.

The anode is a carbon anode or an inert anode, preferably the carbon anode is a graphite anode; and inert anodes include oxide ceramic materials (e.g. doped SnO₂, surface coated SnO₂, CaRuO₃, CaTiₓRu₁₋ₓO₃, LaNiO³, and NiFe₂O₄), metallic materials (e.g. Ni—Fe alloys and Ni—Fe—Y alloys), cermet composites (e.g. Ni—NiO—NiFe₂O₄ and Ni—Fe—NiO—Yb₂O₃—NiFe₂O₄). When the electrolytic cell is in normal operation, the current density of the anode is 0.1-1.5 A/cm².

The liquid alloy is the single rare earth metal (preferably the rare earth metal having a melting point of less than 1000° C., such as La, Ce and Pr), or consists of the single rare earth metal and one or more of Cu, Co, Fe, Ni, Mn, Pb, Sn, In, Sb, and Bi; the density of the liquid alloy is greater than that of the anolyte or the catholyte; and the liquid alloy means to be liquid under working conditions and solid under non-working conditions.

The anolyte is a fluoride system or a chloride system.

The fluoride system comprises single rare earth fluoride with a content of 40-95 wt %, LiF with a content of 5-40 wt % and additive with a content of 0-40 wt %, where the additive is BaF₂ or/and CaF₂; and the fluoride system also contains the rare earth oxide dissolved therein or/and the solid rare earth oxide raw material.

The rare earth oxide raw material (represented by REO) added to the anolyte in the fluoride system undergoes a dissolution reaction and dissociates into rare earth ions (represented by REⁿ⁺) and oxygen-containing ions (represented by O²⁻); under the action of electric field, the oxygen-containing ions undergo oxidation reactions on the anode and evolve O₂ or CO₂ and CO gas; and the rare earth ions undergo reduction reactions at the interface between the liquid alloy and the anolyte to generate rare earth metal atoms and enter the liquid alloy. The reaction formulas are:

O²⁻-2e⁻→0.5O₂↑ inert anode:

O²⁻-2e⁻+1/xC→1/xCOₓ↑(x=1 or 2) or graphite anode:

REⁿ⁺++ne⁻→RE(liquid alloy) interface:

However, incompletely dissolved solid rare earth oxide raw materials at the interface between the liquid alloy and the anolyte may continue to dissolve in the fluoride electrolyte and replenish the rare earth ions continuously consumed at the interface to reduce the concentration polarization and avoid the occurrence of side reactions, or directly occur reduction reactions at the interface, ensuring that the rare earth ions in the anode chamber are continuously reduced to rare earth metal atoms and enter the liquid alloy. The interface reactions are:

REO→REⁿ⁺+O²⁻ interface dissolution reaction:

REO⁺e⁻→RE (liquid alloy)+O²⁻ interface reduction reaction:

According to common general knowledge in the art, REⁿ⁺ or O²⁻ in the anolyte merely represents the ion containing rare earth element or the ion containing oxygen element, and the specific forms may be in a complexed state and a dissociated state.

The chloride system is CaCl₂), or consists of CaCl₂) with one or more of LiCl, NaCl, KCl, BaCl₂, CaF₂, and LiF.

The above chloride system as the anolyte has low solubility for the rare earth oxide raw material, but some solubility for O²⁻. When the rare earth oxide raw material is added to the chloride system anolyte, under the action of electric field, the solid rare earth oxide raw material undergoes reduction reactions directly at the interface between the anolyte and the liquid alloy, the rare earth ions are reduced and enter the liquid alloy, the dissociated O²⁻ dissolve in the electrolyte and migrate to the anode, and then react on the surface of the anode and evolve O₂ (inert anode) or CO₂+CO (graphite anode) gas. The interface reduction reactions are:

REO+e⁻→RE(liquid alloy)+O²⁻

Further, in order to adjust the physicochemical properties of the chloride system anolyte, it is also possible to add fluorides of alkali metals, fluorides of alkaline earth metals, fluorides of rare earth metals, and oxides of alkali metals or alkaline earth metals to the chloride system. A carbonaceous conductive agent or a metal powder may also be mixed into the rare earth oxide raw material, and the rare earth oxide raw material is subjected to shaping and sintering treatment to improve the electrochemical reactivity of the rare earth oxide raw material at the interface.

In the anode chamber, the impurities in the rare earth oxide raw material will have different electrochemical behavior due to the difference in electrode potentials, in which Li, Ca and some rare earth impurity elements that are more active than the RE to be extracted will be enriched in the anolyte, and Fe, Si, Al and other rare earth impurity elements that are more inert than the RE to be extracted will be reduced and enriched in the liquid alloy.

The catholyte comprises single rare earth fluoride with a content of 40-90 wt %, LiF with a content of 10-50 wt % and additive with a content of 0-30 wt %, where the additive is BaF₂ or/and CaF₂.

The solid consumable cathode is M1, the melting point of M1 is higher than that of electrolysis temperature, but M1 can form an alloy whose melting point lower than the electrolysis temperature with the rare earth metal; preferably, M1 is one or more of Fe, Ni, Co, Mn and Cu; and when the electrolytic cell is in normal operation, the current density of the cathode is 0.1-30.0 A/cm².

The liquid cathode is M2, the melting point of M2 is lower than that of electrolysis temperature, and M2 can form an alloy whose melting point lower than the electrolysis temperature with the rare earth metal; preferably, M2 is one or more of Al, Mg, Zn, Sn, Pb, and Sb; and when the electrolytic cell is in normal operation, the current density of the liquid cathode is 0.1-10.0 A/cm². The liquid cathode is connected to negative pole of power supply by inert conductive materials, such as tungsten, molybdenum, tantalum or niobium.

In the cathode chamber, rare earth metal atoms in the liquid alloy are oxidized at the interface between the liquid alloy and the catholyte, and the obtained rare earth ions enter the catholyte and migrate toward the cathode, and are then reduced to rare earth metal atoms; and the rare earth metal atoms undergo alloying reactions with the solid consumable cathode to produce the liquid rare earth alloy product, or enter the liquid cathode to form the rare earth alloy product. The reaction formulas are respectively:

RE(liquid alloy)-ne⁻→REⁿ⁺ interface:

REⁿ⁺+ne⁻+M1(s)→RE-M1(1) solid consumable cathode:

REⁿ⁺+ne⁻+M2(1)→RE-M2(1) or liquid cathode:

For these inert impurity elements (such as Fe, Si and some rare earth elements) of the liquid alloy, they continue to remain in the liquid alloy due to the oxidation potential correction, and do not substantially enter the catholyte. For a small number of impurity elements (e.g. Li, Ca, and other rare earth elements) entering the catholyte from the liquid alloy, electrode position is difficult because the reduction potential of these impurity elements is more negative than that of the rare earth metal element to be extracted, thus also having less effect on the purity of the rare earth alloys.

A receiver is required at the lower end of the cathode to collect liquid rare earth alloy falling from the cathode, and the receiver can be placed in the middle or bottom of the cathode chamber; and the liquid rare earth alloy can be taken out from the receiver by manual scooping method, mechanical scooping method, bottom release method, end crucible method, siphon method or vacuum casting method, and the rare earth alloy product is obtained after cooling and processing.

Utilization of the obtained rare earth alloy product includes, but is not limited to: direct processing into rare earth alloy materials, and master or intermediate alloys for producing structural or functional materials. For example, rare earth magnesium alloys or rare earth aluminum alloys can be used as lightweight structural materials, neodymium iron and samarium cobalt alloys can be used as raw materials for the production of rare earth permanent magnetic materials, lanthanum nickel alloys can be used for the production of hydrogen storage alloys, and some rare earth alloys can be used as raw materials for the production of functional materials such as giant magnetostriction, magnetic refrigeration and electronic conductors.

In view of the important position of high-purity rare earth metal and alloy material products (e.g. target materials) in electronic, information, energy and other industries, the rare earth alloy product can be further used for preparing high-purity rare earth alloy materials or high-purity rare earth metal materials by refining processes; the refining processes include one or more of the combination of vacuum smelting process, vacuum distillation process, electrorefining process, zone smelting process and solid state electromigration process, preferably the vacuum distillation process.

### Beneficial Effects of the Invention

### Beneficial Effects

(1) Electrolytic production is continuous and operable. In this method, the rare earth alloy product is directly produced from the rare earth oxide, which can achieve continuous feeding into the anode chamber and continuous discharging from the cathode chamber, shorten production time, save production costs and improve production efficiency. In addition, the density of the liquid alloy in the bottom layer of the electrolytic cell can be adjusted to be greater than that of the electrolyte and the rare earth oxide raw material, and even an excessive addition of the rare earth oxide raw material will remain at the interface between the liquid alloy and the anolyte and continue to participate in the dissolution/electrochemical reaction, which not only improves the operational adaptability of the electrolytic cell, but also improves the direct utilization of the rare earth oxide.

(2) Rare earth alloys have low levels of impurities. Based on a difference in electrode potentials of different elements, impurities in the rare earth oxide raw material, among which elements more active than the rare earth metal to be extracted (e.g., Li, Ca and some rare earth elements) are enriched in the electrolyte, and elements more inert than the rare earth metal to be extracted (e.g., Si, Fe, Al and other rare earth elements) are enriched in the liquid alloy, which are difficult to enter into the rare earth alloy product. In addition, the content of critical non-metallic impurities such as C and O can also be reduced because the carbon residue produced by the graphite anode, rare earth oxyfluoride sludge and oxygen ion-containing anolyte in the anode chamber all do not contact with the catholyte and the rare earth alloy product in the cathode chamber. The rare earth alloys obtained by electrolysis can be further purified by refining processes to obtain rare earth metal and rare earth alloy materials.

(3) It is economical, clean and environmental-friendly. In view of the purification and impurity removal function of the electrolytic cell used, the requirements for the impurity content of the rare earth oxide raw material can be appropriately relaxed, the purification pressure in the upstream rare earth oxide production industry can be reduced, and the raw material cost in the electrolysis process can also be reduced, and the direct electrolysis product is rare earth alloy, which can not only be directly applied to the production of rare earth alloy materials, but also be further refined to high-purity rare earth metal materials with higher value. In addition, this method is free of corrosive gases, waste liquid and a large amount of waste residue, and the further use of inert anode can also avoid the production of CO₂ and CO gases.

### BRIEF DESCRIPTION OF THE DRAWINGS

In order to illustrate the equipment used in the present invention and the working principles and methods thereof more clearly, FIGS. 1A-1C show a schematic cross-sectional view of the electrolytic cell used in the present invention. For ordinary technical personnels in this field, other figures can also be obtained according to FIGS. 1A-1C without any creative effort.

FIGS. 1A-1C are schematic structural diagrams of the electrolytic cell of the present invention, where FIG. 1A is a schematic structural diagram of the electrolytic cell with a solid consumable cathode, in which a collector containing liquid rare earth alloy product is located in the middle of the cathode chamber, FIG. 1B is a schematic structural diagram of the electrolytic cell with another solid consumable cathode, in which a collector containing liquid rare earth alloy product is located at the bottom of the cathode chamber, and FIG. 1C is a schematic structural diagram of the electrolytic cell with liquid cathode.

Reference numerals: 1—partition, 2—anode, 3—electrolytic cell, 4—anolyte, 5—liquid alloy, 6—catholyte, 7—collector with liquid rare earth alloy, 8—cathode, and 9—liquid cathode.

### DETAILED DESCRIPTION OF THE EMBODIMENTS

In order to make the objectives, technical solution and advantages of the present invention become more apparent, a detailed description of the technical solution of the present invention will be provided below. Obviously, the described embodiments are only a few, but not all embodiments of the present invention. Based on the embodiments of the present invention, all other embodiments obtained by a person skilled in the art without creative efforts fall within the scope of the present invention.

The method for preparing rare earth alloys of the present invention is to perform molten salt electrolysis reactions at 800-1100° C. and add the rare earth oxide raw material into the anode chamber, oxidation reactions occur on the surface of the anode, and rare earth ions (in a dissolved state or/and an undissolved state) in the anode chamber are reduced to rare earth metal atoms at the interface between the liquid alloy and the anolyte and enter the liquid alloy; in the cathode chamber, rare earth metal atoms in the liquid alloy are oxidized to rare earth ions at the interface between the liquid alloy and the catholyte and enter the catholyte, the rare earth ions in the catholyte are reduced to rare earth metal atoms at the cathode, and the rare earth metal atoms enter the liquid cathode to form the rare earth alloy product, or undergo alloying reactions with the solid consumable cathode to produce the liquid rare earth alloy product.

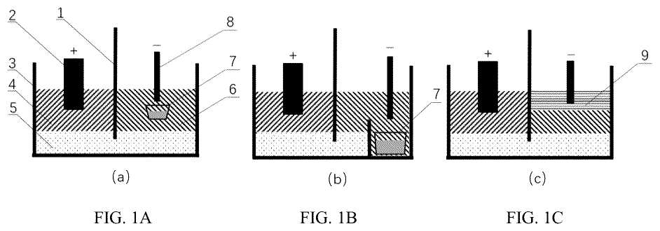

According to the present invention, the anolyte and the catholyte are physically separated by the electrolytic cell, while both the anolyte and the catholyte are in contact with the liquid alloy. Therefore, in order to effectively realize the separation of the catholyte and the anolyte, a structure of the electrolytic cell is as shown in FIGS. 1A-1C, where FIG. 1A is a schematic structural diagram of the electrolytic cell with a solid consumable cathode, in which a collector containing liquid rare earth alloy product is located in the middle of the cathode chamber, FIG. 1B is a schematic structural diagram of the electrolytic cell with another solid consumable cathode, in which a collector containing liquid rare earth alloy product is located at the bottom of the cathode chamber, and FIG. 1C is a schematic structural diagram of the electrolytic cell with liquid cathode.

The electrolytic cell is spatially divided into the anode chamber and the cathode chamber by the insulating partition 1. The anode chamber contains the anolyte 4, the anode 2 is inserted into the anolyte 4, the cathode chamber contains the catholyte 6, the cathode 8 is inserted into the catholyte 6 or the liquid cathode 9, and the bottom of the electrolytic cell contains the liquid alloy 5 in contact with the anolyte 4 and the catholyte 6, respectively, but not with the anode 2 or the cathode 8 or the liquid cathode 9.

If the cathode 8 is a solid consumable cathode, the collector 7 is required to hold the liquid rare earth alloy product, and if the liquid cathode 9 is used, the cathode 8 is an inert metal material.

In addition to the electrolytic cell shown in FIGS. 1A-1C, the structure of the electrolytic cell can also be designed in many forms, such as a U-shaped electrolytic cell. Further, the shape of the electrolytic cell can be varied, for example, the bottom of the electrolytic cell is not limited to a flat bottom, but can also be a trapezoidal bottom and a round bottom.

Rare earth electrolytic cells capable of achieving physical separation of the anolyte and the catholyte, and the mediation function of liquid alloy, can be applicable to the method of the present invention.

In scale applications, the electrolytic cell may be operated in series or in parallel with each other.

### Example 1

A pre-alloyed La—Ni alloy with the Ni content of 25 wt % was contained at the bottom of the electrolytic cell, the inert anode made of 65.8 wt % La₂O₃+33.7 wt % Ni₂O₃+0.5 wt % In₂O₃ ceramic material was used as the anode, and a pure nickel rod was used as the cathode. Lanthanum oxide was used as the raw material with the REO content of 96.3 wt % and the La₂O₃/REO of 97.1 wt %. The anolyte was 60 wt % LaF₃+27 wt % LiF+13 wt % BaF₂, the above lanthanum oxide raw material was added, and the catholyte was 65 wt % LaF₃+35 wt % LiF. The electrolytic cell was placed in an atmosphere filled with dry argon and the temperature was raised by programs to 950° ° C. and heat preservation for 2 h, the current density of the cathode was controlled at 0.1 A/cm² by current conduction, the above lanthanum oxide raw material was periodically added after the start of electrolysis, and the lanthanum-nickel alloy with the La/REM of 99.95 wt % was obtained after electrolysis.

The obtained lanthanum-nickel alloy can be prepared as a rare earth hydrogen storage alloy for use in hydrogen fuel electrolytic cells/nickel-hydrogen batteries, and can also be used as a scavenger or modifier for steel or nonferrous metal melts, such as for deoxidation of nickel-containing stainless steels.

### Example 2

Metal Ce was contained at the bottom of the electrolytic cell, graphite was used as the anode, and the liquid aluminum cathode inserted with a conductive tungsten rod was used as the cathode. Cerium oxide was used as the raw material with the REO content of 96.2 wt % and the CeO₂/REO of 98.6 wt %. The anolyte was 65 wt % CeF₃+35 wt % LiF, the above cerium oxide raw material was added, and the catholyte was 65 wt % CeF₃+35 wt % LiF. The electrolytic cell was placed in an atmosphere filled with dry argon and the temperature was raised by programs to 860° ° C. and heat preservation for 2 h, the current density of the cathode was controlled at 0.1 A/cm² by current conduction, the above cerium oxide raw material was periodically added after the start of electrolysis, and the aluminum-cerium alloy with the Ce/REM of 99.94 wt % was obtained after electrolysis.

The obtained aluminum-cerium alloy can be used as an intermediate alloy for the production of cerium-containing aluminum alloy materials.

### Example 3

A pre-alloyed Pr—Fe alloy with the Fe content of 10 wt % was contained at the bottom of the electrolytic cell, graphite was used as the anode and a pure iron rod was used as the cathode. Praseodymium oxide was used as the raw material with the REO content of 97.6 wt % and the Pr₆O₁₁/REO of 95.9 wt %. The anolyte was 45 wt % PrF₃+20 wt % LiF+35 wt % BaF₂, the above praseodymium oxide raw material was added, and the catholyte was 50 wt % PrF₃+50 wt % LiF. The electrolytic cell was placed in an atmosphere filled with dry argon and the temperature was raised by programs to 1000° C. and heat preservation for 2 h, the current density of the cathode was controlled at 2.0 A/cm² by current conduction, the above praseodymium oxide raw material was periodically added after the start of electrolysis, and the praseodymium iron alloy with the Pr/REM of 99.87 wt % was obtained after electrolysis.

The obtained praseodymium iron alloy can be used as the additive in the production of neodymium iron boron permanent magnetic materials.

### Example 4

A pre-alloyed Nd—Fe alloy with the Fe content of 15 wt % was contained at the bottom of the electrolytic cell, graphite was used as the anode and a pure iron rod was used as the cathode. Neodymium oxide was used as the raw material with the REO content of 98.3 wt % and the Nd₂O₃/REO of 98.7 wt %. The anolyte was 83 wt % NdF₃+10 wt % LiF+7 wt % BaF₂, the above neodymium oxide raw material was added, and the catholyte was 80 wt % NdF₃+20 wt % LiF. The electrolytic cell was placed in an atmosphere filled with dry argon and the temperature was raised by programs to 1050° C. and heat preservation for 2 h, the current density of the cathode was controlled at 6.0 A/cm² by current conduction, the above neodymium oxide raw material was periodically added after the start of electrolysis, and the praseodymium iron alloy with the Nd/REM of 99.92 wt % was obtained after electrolysis.

The obtained neodymium iron alloy can be used for preparing neodymium iron boron permanent magnetic materials.

### Example 5

A pre-alloyed Sm—Co alloy with the Co content of 20 wt % was contained at the bottom of the electrolytic cell, graphite was used as the anode, and a pure cobalt rod was used as the cathode. Samarium oxide was used as the raw material with the REO content of 92.4 wt % and the Sm₂O₃/REO of 98.8 wt %. The anolyte was CaCl₂) and the catholyte was 80 wt % SmF₃+20 wt % LiF. The electrolytic cell was placed in an atmosphere filled with dry argon and the temperature was raised by programs to 950° C. and heat preservation for 2 h, the above samarium oxide raw material was added before the start of electrolysis, the current density of the cathode was controlled at 1.5 A/cm² by current conduction, the above samarium oxide raw material was added again during electrolysis, and the samarium cobalt alloy with the Sm/REM of 99.94 wt % was obtained after electrolysis.

The obtained samarium-cobalt alloy can be used for preparing samarium-cobalt permanent magnetic materials, or samarium, which is an easily evaporable component, is separated by vacuum distillation process (900° C., <10 Pa), and after condensation, high-purity metal samarium (Sm/REM≥99.99 wt %) is obtained.

### Example 6

A pre-alloyed Eu—Pb alloy with the Pb content of 80 wt % was contained at the bottom of the electrolytic cell, graphite was used as the anode and the liquid tin cathode inserted with a conductive tungsten rod was used as the cathode. The raw material was europium oxide with the REO content of 96.9 wt % and the Eu₂O₃/REO of 92.3 wt %. The anolyte was CaCl₂)—NaCl in a molar ratio of 3:1 and the catholyte was 70 wt % EuF₃+30 wt % LiF. The electrolytic cell was placed in an atmosphere filled with dry argon and the temperature was raised by programs to 850° C. and heat preservation for 2 h, the above europium oxide raw material was added before the start of electrolysis, the current density of the cathode was controlled at 5.0 A/cm² by current conduction, the above samarium oxide raw material was added again during electrolysis, and the tin-europium alloy with the Eu/REM of 99.64 wt % was obtained after electrolysis.

The obtained tin-europium alloy can be vacuum distilled (900° ° C., <10 Pa) to separate europium which is an easily evaporable component, and then high-purity metallic europium (Eu/REM≥99.95 wt %) can be obtained after condensation.

### Example 7

A pre-alloyed Dy—Cu alloy with the Cu content of 52 wt % was contained at the bottom of the electrolytic cell, graphite was used as the anode, and a pure iron rod was used as the cathode. Dysprosium oxide was used as the raw material with the REO content of 98.8 wt % and the Dy₂O₃/REO of 99.1 wt %. The anolyte was 90 wt % DyF₃+10 wt % LiF, the above dysprosium oxide raw material was added, and the catholyte was 66 wt % DyF₃+34 wt % LiF. The electrolytic cell was placed in an atmosphere filled with dry argon and the temperature was raised by programs to 1050° C. and heat preservation for 2 h, the current density of the cathode was controlled at 3.5 A/cm² by current conduction, the above dysprosium oxide raw material was periodically added after the start of electrolysis, and the dysprosium iron alloy with the Dy/REM of 99.95 wt % was obtained after electrolysis.

The obtained Fe—Dy alloy can be used for the preparation of rare earth functional materials such as neodymium-iron-boron materials and giant magnetostrictive materials.

### Example 8

A pre-alloyed Yb—Sn alloy with the Sn content of 70 wt % was contained at the bottom of the electrolytic cell, a 25 wt % Ni-35 wt % Fe-10 wt % NiO-2 wt % Yb₂O₃-28 wt % NiFe₂O₄ metal ceramic composite inert anode was used as the anode, and a pure copper rod was used as the cathode. Ytterbium oxide was used as the raw material, with the REO content of 98.8 wt % and the Yb₂O₃/REO of 98.7 wt %. The anolyte was CaCl₂)—LiCl—BaCl₂ in a molar ratio of 80:15:5 and the catholyte was 75 wt % YbF₃+25 wt % LiF. The electrolytic cell was placed in an atmosphere filled with dry argon and the temperature was raised by programs to 850° C. and heat preservation for 2 h, the above ytterbium oxide raw material was added before the start of electrolysis, and the current density of the cathode was controlled at 3.0 A/cm² by current conduction, the above ytterbium oxide raw material was further added during electrolysis, and the copper ytterbium alloy with the Yb/REM of 99.91 wt % was obtained after electrolysis.

### Example 9

A pre-alloyed Y—Co alloy with the Co content of 28 wt % was contained at the bottom of the electrolytic cell, the inert anode made of 60 wt % Ni-30 wt % Fe-5 wt % Y-5 wt % Mn alloy material was used as the anode, and a pure manganese rod was used as the cathode. Yttrium oxide was used as the raw material with the REO content of 98.3 wt % and the Y₂O₃/REO of 98.9 wt %. The anolyte was 75 wt % YF₃+15 wt % LiF+10 wt % CaF₂, the above yttria raw material was added and the catholyte was 90 wt % YF₃+10 wt % LiF. The electrolytic cell was placed in an atmosphere filled with dry argon and the temperature was raised by programs to 1050° C. and heat preservation for 2 h, the current density of the cathode was controlled to be 30.0 A/cm² by current conduction, the above yttrium oxide raw material was periodically added after the start of electrolysis, and the manganese-yttrium alloy with the Y/REM of 99.86 wt % was obtained after electrolysis.

The obtained manganese-yttrium alloy can be used as the additive for magnesium alloy production to improve its mechanical properties and processing properties.

### Example 10

A pre-alloyed Y—Co alloy with the Co content of 28 wt % was contained at the bottom of the electrolytic cell, graphite was used as the anode, and the Mg liquid cathode inserted with a conductive tungsten rod was used as the cathode. Yttrium oxide was used as the raw material with the REO content of 98.3 wt % and the Y₂O₃/REO of 98.9 wt %. The anolyte was 65 wt % YF₃+35 wt % LiF, the above yttria raw material was added, and the catholyte was 65 wt % YF₃+25 wt % LiF+10 wt % BaF₂. The electrolytic cell was placed in an atmosphere filled with dry argon and the temperature was raised by programs to 880° C. and heat preservation for 2 h, the current density of the cathode was controlled to be 0.5 A/cm² by current conduction, the above yttrium oxide raw material was periodically added after the start of electrolysis, and the yttrium magnesium alloy with the Y/REM of 99.93 wt % was obtained after electrolysis.

The obtained yttrium magnesium alloy can be used as the intermediate alloy for the production of magnesium alloy materials.

### Example 11

A pre-alloyed Sc—Cu alloy with the Cu content of 80 wt % was contained at the bottom of the electrolytic cell, the inert anode made of CaRuO₃ ceramic material was used as the anode, and the liquid aluminum cathode inserted with a conductive tungsten rod was used as the cathode. Scandium oxide was used as the raw material with the REO content of 91.8 wt % and the Sc₂O₃/REO of 99.3 wt %. The anolyte was CaCl₂)—KCl in a molar ratio of 4:1 and the catholyte was 40 wt % ScF₃+30 wt % LiF+20 wt % BaF₂+10 wt % CaF₂. The electrolytic cell was placed in an atmosphere filled with dry argon and the temperature was raised by programs to 950° C. and heat preservation for 2 h; the above scandium oxide raw material was added before the start of electrolysis, and the current density of the cathode was controlled at 1.0 A/cm² by current conduction; the above scandium oxide raw material was periodically added after the start of electrolysis, and the aluminum scandium alloy with the Sc/REM of 99.97 wt % was obtained after electrolysis.

The obtained aluminum scandium alloy can be used as the intermediate alloy for the production of aluminum alloy materials.

### Comparative Example 1

This Comparative example 1 differs from Example 1 in that: the bottom of the electrolytic cell does not contain the La—Ni alloy, the anolyte and the catholyte are both 65 wt % LaF₃+35 wt % LiF, and other conditions are the same. A lanthanum-nickel alloy with La/REM of 97.79 wt % was obtained after electrolysis.

It is concluded that in the absence of the liquid alloy, the separation and purification effect based on the electrochemical reaction at the liquid alloy/molten salt electrolyte interface doesn't exist, and the rare earth alloy produced from electrolysis of rare earth oxides in the electrolytic cell with an ordinary partition has a lower purity, a significantly higher content of non-rare earth impurities such as Fe and O, and other rare earth impurities such as Ce and Pr.

### Comparative Example 2

This Comparative example 2 differs from Example 7 in that the cathode is tungsten as an inert cathode material, and other conditions are the same. After electrolysis, solid dysprosium metal with Dy/REM of 99.91 wt % was obtained, and the content of non-metallic impurity F was high.

The above is only the specific implementations of the present invention, but the protection scope of the present invention is not limited here. Any change or equivalent made by a person skilled in the art within the technical scope disclosed by the present invention fall within the protection scope of the present invention. Accordingly, the scope of protection of the present invention shall be subject to the scope of protection of the claims.

What is claimed is:

1. A method for preparing rare earth alloys, wherein the method is implemented by using an electrolytic cell divided into an anode chamber and a cathode chamber, wherein an anolyte and an anode are provided in the anode chamber, a catholyte and a cathode are provided in the cathode chamber, a liquid alloy is contained at a bottom of the electrolytic cell, and the anolyte and the catholyte are not in contact with each other but are connected via the liquid alloy;
the cathode is a solid consumable cathode or a liquid cathode; and
the method comprises: powering on the electrolytic cell to operate, adding a rare earth oxide raw material to the anode chamber, and obtaining a liquid rare earth alloy product in the cathode chamber.

2. The method for preparing the rare earth alloys according to claim 1, wherein in the rare earth oxide raw material, a content of a total rare earth oxide is ≥90 wt %, and a single rare earth oxide accounts for 90 wt % or above of the total rare earth oxide; and the single rare earth oxide is one of lanthanum oxide, cerium oxide, praseodymium oxide, neodymium oxide, samarium oxide, europium oxide, gadolinium oxide, terbium oxide, dysprosium oxide, holmium oxide, erbium oxide, thulium oxide, ytterbium oxide, lutetium oxide, yttrium oxide, and scandium oxide.

3. The method for preparing the rare earth alloys according to claim 1, wherein a relative purity of a single rare earth metal in the liquid rare earth alloy product is ≥99.0 wt %.

4. The method for preparing the rare earth alloys according to claim 1, wherein the anode is a carbon anode or an inert anode.

5. The method for preparing the rare earth alloys according to claim 1, wherein the liquid alloy is a single rare earth metal or consists of a single rare earth metal and one or more of Cu, Co, Fe, Ni, Mn, Pb, Sn, In, Sb, and Bi; and
a density of the liquid alloy is greater than a density of the anolyte or a density of the catholyte.

6. The method for preparing the rare earth alloys according to claim 1, wherein the anolyte is a fluoride system or a chloride system;
the fluoride system comprises a single rare earth fluoride with a content of 40-95 wt %, LiF with a content of 5-40 wt %, and an additive with a content of 0-40 wt %, wherein the additive is BaF₂ or/and CaF₂; and the fluoride system further comprises the rare earth oxide dissolved the fluoride system or/and a solid rare earth oxide raw material; and
the chloride system is CaCl₂, or consists of CaCl₂ with one or more of LiCl, NaCl, KCl, BaCl₂, CaF₂, and LiF.

7. The method for preparing the rare earth alloys according to claim 1, wherein the catholyte comprises a single rare earth fluoride with a content of 40-90 wt %, LiF with a content of 10-50 wt %, and an additive with a content of 0-30 wt %, wherein the additive is BaF₂ or/and CaF₂.

8. The method for preparing the rare earth alloys according to claim 1, wherein the solid consumable cathode is M1, a melting point of the M1 is higher than an electrolysis temperature, and the M1 is allowed to form an alloy having the melting point lower than the electrolysis temperature with a rare earth metal; and when the electrolytic cell is in a normal operation, a current density of the cathode is 0.1-30.0 A/cm².

9. The method for preparing the rare earth alloys according to claim 1, wherein the liquid cathode is M2, a melting point of the M2 is lower than an electrolysis temperature, and the M2 is allowed to form an alloy having the melting point lower than the electrolysis temperature with a rare earth metal; and when the electrolytic cell is in a normal operation, a current density of the liquid cathode is 0.1-10.0 A/cm².

10. The method for preparing the rare earth alloys according to claim 1, wherein the liquid rare earth alloy product is configured for preparing high-purity rare earth alloy materials or high-purity rare earth metal materials by refining processes; and
the refining processes comprise one or a combination of two or more of a vacuum smelting process, a vacuum distillation process, an electrorefining process, a zone smelting process, and a solid state electromigration process.

11. The method for preparing the rare earth alloys according to claim 8, wherein the M1 is one or more of Fe, Ni, Co, Mn and Cu.

12. The method for preparing the rare earth alloys according to claim 9, wherein the M2 is one or more of Al, Mg, Zn, Sn, Pb, and Sb.

13. The method for preparing the rare earth alloys according to claim 5, wherein the anolyte is a fluoride system or a chloride system;
the fluoride system comprises a single rare earth fluoride with a content of 40-95 wt %, LiF with a content of 5-40 wt %, and an additive with a content of 0-40 wt %, wherein the additive is BaF₂ or/and CaF₂; and the fluoride system further comprises the rare earth oxide dissolved in the fluoride system or/and a solid rare earth oxide raw material; and
the chloride system is CaCl₂), or consists of CaCl₂) with one or more of LiCl, NaCl, KCl, BaCl₂, CaF₂, and LiF.

14. The method for preparing the rare earth alloys according to claim 5, wherein the catholyte comprises a single rare earth fluoride with a content of 40-90 wt %, LiF with a content of 10-50 wt %, and an additive with a content of 0-30 wt %, wherein the additive is BaF₂ or/and CaF₂.

15. The method for preparing the rare earth alloys according to claim 10, wherein the refining processes comprise the vacuum distillation process.
